(19) United States
(12) Patent Application Publication
(10) Pub. No.: US 2008/0258100 A1
(43) Pub. Date: Oct. 23, 2008

(54) PIEZOELECTRIC CERAMIC COMPOSITION AND RESONATOR

(75) Inventors: Keisuke Teranishi, Tokyo (JP); Masakazu Hirose, Tokyo (JP); Tomohisa Azuma, Tokyo (JP)

Correspondence Address: PEARNE & GORDON LLP, 1801 EAST 9TH STREET, SUITE 1200, CLEVELAND, OH, 44114-3108, US

(73) Assignee: TDK CORPORATION, Tokyo (JP)

(21) Appl. No.: 11/851,415

(22) Filed: Sep. 7, 2007

(30) Foreign Application Priority Data
Sep. 12, 2006 (JP) 2006-246316
Aug. 28, 2007 (JP) 2007-220642

(51) Int. Cl. C04B 35/36

(52) U.S. Cl. 252/62.9 PZ

(57) ABSTRACT

To obtain a piezoelectric ceramic composition having extremely high heat resisting property. Provided is a piezoelectric ceramic composition comprising a main component represented by Pbₐ[(Mn_{b}Nb_{c})_{d}TiₑZr_{f}]O₃ (wherein 0.98≦a≦1.01, 0.340≦b≦0.384, 0.616≦c≦0.660, 0.08≦d≦0.12, 0.500≦e≦0.540, 0.37≦f≦0.41, bd+cd+e+f=1), and 1 to 10% by weight of Al in terms of Al₂O₃ as an additive. Preferably, b is such that 0.345≦b≦0.375 and c is such that 0.625≦c≦0.655, and the Al as the additive is preferably 2 to 6% by weight in terms of Al₂O₃.

### BACKGROUND OF THE INVENTION

1. Field of the Invention

The present invention relates to a piezoelectric ceramic composition, and more specifically, to a piezoelectric ceramic composition having high heat resisting property and suitable for a resonator.

2. Description of the Related Art

Ever since it was discovered that Pb(Zr.Ti)O₃ (hereinafter, “PZT”) having a composition near the morphotropic phase boundary exhibit excellent piezoelectric properties, this piezoelectric material has been applied to various product fields because the piezoelectric material has a high Curie temperature and is excellent in terms of change by temperature and change over time. In the case of a resonator, which is one of the applications of piezoelectric materials, a piezoelectric material is required to have a large Qₘₐₓ (Qₘₐₓ=tan θₘₐₓ; θₘₐₓ being the maximum value of the phase angle between the resonant frequency and anti-resonant frequency) as an electrical property. Such a resonator is prepared as a surface mount device. In this case, a piezoelectric material is required to have heat resisting property because the piezoelectric material is passed through a solder reflow furnace when it is mounted onto a printed circuit board. Here, the expression “high heat resisting property” or “excellent heat resisting property” refers to having a small variation in properties after undergoing a thermal shock.

A piezoelectric ceramic composition having improved heat resisting property is disclosed in Patent Document 1 (International Patent Publication WO 2005/092817). This piezoelectric ceramic composition is characterized by having a main component represented by Pbₐ[(Mn_{1/3}Nb_{2/3})ₓTi_{y}Zr_{z}]O₃ (wherein 0.97≦a≦1.01, 0.04≦x≦0.16, 0.48≦y≦0.58, 0.32≦z≦0.41), and as an additive, at least one element selected from the group consisting of Al, Ga, In, Ta and Sc in an amount of 0.01 to 15.0% by weight in terms of an oxide of the respective elements.

The piezoelectric ceramic composition disclosed in Patent Document 1 exhibits excellent heat resisting property having an absolute value |ΔF₀| of the rate of change in oscillation frequency F₀ between before and after application of a thermal shock of about 0.07%. This heat resisting property |ΔF₀| is determined in the following manner. F₀ of an obtained sample is measured (before test), and the sample is then wrapped with aluminum foil and immersed in a solder bath at 265° C. for 10 seconds. Then, the sample is taken out from the aluminum foil and left to stand in air at room temperature for 24 hours. After being left to stand for 24 hours, F₀ is measured again (after test). The rate of change in F₀ between before and after the test (after 24 hours) is determined based on the following formula (1) and heat resisting property is evaluated according to its absolute value (|ΔF₀|). As defined in formula (1), |ΔF₀| is the absolute value of the rate of change in oscillation frequency F₀ between before and after application of a thermal shock.

$$Δ {F}_{0} = \frac{{F}_{0} ( after test ) - {F}_{0} ( before test )}{{F}_{0} ( after test )} \times 100 ( \% ) \qquad formula ( 1 )$$

However, there is a need for further improvement in this heat resisting property. Accordingly, it is an object of the present invention to provide a piezoelectric ceramic composition having higher heat resisting property than those of Patent Document 1, and specifically, heat resisting property given by the above described |ΔF₀| of 0.05% or less.

### SUMMARY OF THE INVENTION

The present inventors conducted investigations into improving the heat resisting property of the piezoelectric ceramic composition of Patent Document 1 having a main component represented by Pbₐ[(Mn_{1/3}Nb_{2/3})ₓTi_{y}Zr_{z}]O₃. This main component is adjusted to contain both Mn and Nb in stoichiometric amounts. However, the present inventors confirmed that heat resisting property can be improved by making Mn richer within a predetermined range than the stoichiometric amount (⅓=0.333) and the Nb poorer within a predetermined range than the stoichiometric amount (⅔=0.667). The present invention is based on this finding, and is directed to a piezoelectric ceramic composition comprising a main component represented by Pbₐ[(Mn_{b}Nb_{c})_{d}TiₑZr_{f}]O₃, wherein in the composition formula a to f satisfy 0.98≦a≦1.01, 0.340≦b≦0.384, 0.616≦c≦0.660, 0.08≦d≦0.12, 0.500≦e≦0.540, 0.37≦f≦0.41, bd+cd+e+f=1, and 1 to 10% by weight of Al in terms of Al₂O₃ as an additive.

In the piezoelectric ceramic composition according to the present invention, b is preferably such that 0.345≦b≦0.375 and c is preferably such that 0.625≦c≦0.655. Further, the piezoelectric ceramic composition preferably comprises as the additive 2 to 6% by weight, and more preferably 2 to 4% by weight of Al in terms of Al₂O₃.

According to the present invention, a piezoelectric ceramic composition can be obtained, which has an absolute value |ΔF₀| of the rate of change (ΔF₀) in oscillation frequency F₀ according to the following formula (1) of 0.05% or less.

$$Δ {F}_{0} = \frac{{F}_{0} ( after test ) - {F}_{0} ( before test )}{{F}_{0} ( after test )} \times 100 ( \% ) \qquad formula ( 1 )$$

F₀ (before test): Oscillation frequency measured before the application of a thermal shock.

F₀ (after test): Oscillation frequency measured by wrapping in aluminum foil a sample whose F₀ (before test) had been measured, immersing the sample in a solder bath at 265° C. for 10 seconds (thermal shock application), then taking the sample out from the aluminum foil and leaving the sample to stand in air at room temperature for 24 hours, and then measuring F₀.

According to the present invention, a piezoelectric ceramic composition having extremely excellent heat resisting property wherein the above-described |ΔF₀| is 0.05% or less can be obtained.

In addition, the present invention provides a resonator comprising a piezoelectric resonator provided with a vibrating electrode formed thereon and a substrate for supporting the piezoelectric resonator, wherein the piezoelectric resonator is constituted from a piezoelectric ceramic comprising the above-mentioned composition.

### BRIEF DESCRIPTION OF THE DRAWINGS

FIG. 1A is a diagram illustrating the appearance of the specimen prepared in the Examples;

FIG. 1B is a diagram illustrating the appearance of the specimen prepared in the Examples;

FIG. 2 is an exploded perspective view illustrating the structure of the resonator prepared in the Examples;

FIG. 3 is a graph illustrating the waveform when spurious vibrations are present;

FIG. 4 is a graph illustrating the waveform when spurious vibrations are not present;

FIG. 5 is a graph illustrating the relationship between b (Mn amount) and the heat resisting property |ΔF₀|;

FIG. 6 is a graph illustrating the relationship between b (Mn amount) and the electromechanical coupling factor k₁₅;

FIG. 7 is a graph illustrating the relationship between b (Mn amount) and the electrical property Qₘₐₓ;

FIG. 8 is a graph illustrating the relationship between Al₂O₃ amount and the heat resisting property |ΔF₀|;

FIG. 9 is a graph illustrating the relationship between Al₂O₃ amount and the electromechanical coupling factor k₁₅; and

FIG. 10 is a graph illustrating the relationship between Al₂O₃ amount and the electrical property Qₘₐₓ.

### BRIEF DESCRIPTION OF THE REFERENCE NUMERALS

10 Resonator
11 Substrate
111, 112 Terminal electrodes
12, 16 Adhesive resin layer
13, 15 Cavity resin layer
14 Piezoelectric resonator
141 Vibrating electrode
17 Cover

### DETAILED DESCRIPTION OF THE PREFERRED EMBODIMENTS

The piezoelectric ceramic composition according to the present invention will now be described below in detail based on the embodiment.

### <Piezoelectric Ceramic Composition>

The piezoelectric ceramic composition according to the present invention comprises a main component represented by the following formula (2). This main component is composed of a perovskite compound. Further, the piezoelectric ceramic composition according to the present invention is typically constituted by a sintered body. This sintered body comprises grains having the above-described main component and a grain boundary phase between the grains.

Pbₐ[(Mn_{b}Nb_{c})_{d}TiₑZr_{f}]O₃ (2)

wherein, 0.98≦a≦1.01,

0.340≦b≦0.384,

0.616≦c≦0.660,

0.08≦d≦0.12,

0.500≦e≦0.540,

0.37≦f≦0.41,

bd+cd+e+f=1

In formula (2), a, b, c, d, e and f all represent molar ratios.

Next, the reason for the limitations of a, b, c, d, e and f in the formula (2) will be explained.

### <Pb>

“a”, which represents the amount of Pb, is in the range of 0.98≦a≦1.01. If “a” is less than 0.98, it is difficult to obtain a dense sintered body. On the other hand, if “a” exceeds 1.01, good heat resisting property cannot be obtained. “a” is preferably such that 0.985≦a≦1.005, and is more preferably such that 0.985≦a≦1.000.

### <Mn and Nb>

The stoichiometric composition of Mn and Nb in formula (2) is Mn_{1/3} and Nb_{2/3}. Patent Document 1 employs a stoichiometric composition for Mn and Nb. In contrast, the present invention employs a composition in which Mn of 0.340≦b≦0.384 is richer than the stoichiometric amount, and Nb of 0.616≦c≦0.660 is poorer than the stoichiometric amount. By employing such a non-stoichiometric composition for Mn and Nb, the present invention can attain especially excellent heat resisting property having the above-described |ΔF₀| of 0.05% or less. It is described in Patent Document 2 (Japanese Patent Laid-Open No. 2002-60269) that the ratio between the Mn amount and the Nb amount is made larger than the stoichiometric ratio, in other words, the amount of Mn is richer than the stoichiometric amount. However, Patent Document 2 does not suggest improvement in heat resisting property wherein |ΔF₀| can be 0.05% or less.

If “b” is less than 0.340 (c exceeds 0.660), heat resisting property |F₀| of 0.05% or less can no longer be obtained. Further, if “b” exceeds 0.384 (c is less than 0.616), ohmic resistance deteriorates, whereby polarization becomes impossible.

“b”, which represents the amount of Mn, is in the range of 0.340≦b≦0.384, and “c”, which represents the amount of Nb, is in the range of 0.616≦c≦0.660. Preferably, “b” is such that 0.345≦b≦0.375 and “c” is such that 0.625≦c≦0.655. More preferably, “b” is such that 0.345≦b≦0.370 and “c” is such that 0.630≦c≦0.655.

“d”, which represents the total amount of Mn and Nb in formula (2), is in the range of 0.08≦d≦0.12. If “d” is less than 0.08, the electrical property Qₘₐₓ becomes smaller. On the other hand, if “d” exceeds 0.12, good heat resisting property cannot be obtained. Accordingly, d is in the range of 0.08≦d≦0.12. “d” is preferably such that 0.085≦d≦0.115, and is more preferably such that 0.09≦d≦0.11.

### <Ti>

“e”, which represents the amount of Ti, is in the range of 0.500≦e≦0.540. If “e” is less than 0.500, good heat resisting property cannot be obtained. On the other hand, if “e” exceeds 0.540, Qₘₐₓ becomes smaller. “e” is preferably such that 0.505≦e≦0.535, and is more preferably such that 0.505≦e≦0.520.

### <Zr>

“f”, which represents the amount of Zr, is in the range of 0.37≦f≦0.41. If “f” is less than 0.37, Qₘₐₓ becomes smaller. If “f” exceeds 0.41, good heat resisting property cannot be obtained. Therefore, while “f” is in the range of 0.37≦f≦0.41, preferred is 0.380≦f≦0.405, and more preferred is 0.385≦f≦0.400.

Although “b”, “c”, “d”, “e” and “f” in the formula (2) satisfies bd+cd+e+f=1, they typically satisfies b+c=1 and d+e+f=1.

The present invention comprises the above as a main component, and further comprises 1 to 10% by weight of Al in terms of Al₂O₃ as an additive.

As illustrated in Patent Document 1, it is believed that Al₂O₃ forms a solid solution in the grains (lattice) comprising the main component (PZT) to exert an effect on improving the heat resisting property of the main component itself, and that excessive Al₂O₃ incapable of forming solid solution in the grains is randomly precipitated mainly in the grain boundary phase of the sintered body to strengthen the binding between grains, which contributes to improvement in mechanical strength.

In the present invention, it was found that an electromechanical coupling factor can be reduced by adding Al₂O₃. Resonators, which are one of the applications of piezoelectric materials, continue to decrease in size. Miniaturized resonators sometimes cannot sufficiently confine the main vibration. Therefore, in such resonators, unnecessary vibrations (spurious vibrations) are likely to occur. Here, the expression “confine the main vibration” refers to the state wherein a single vibration is generated on the vibrating electrode sections formed on both surfaces of the piezoelectric body, whereby vibrations are attenuated in the sections (non-electrode sections) free from a vibrating electrode so that unnecessary vibrations are scarcely present. If the piezoelectric element is large, vibrations can be sufficiently attenuated since the non-electrode sections can be large. However, for a small resonator, there are less non-electrode sections. In such case, the vibrations might not be sufficiently attenuated, whereby unnecessary vibrations are more likely to occur. If unnecessary vibrations increase, when the electromechanical coupling factor of the piezoelectric material is large, the frequency of the main vibration and that of the unnecessary vibrations overlap or approximate each other, which makes it more difficult to confine only the main vibration. While it is possible to separate the frequency of the main vibration and that of the unnecessary vibrations by reducing the electromechanical coupling factor, the Al₂O₃ in the present invention can also deal with this problem. Further, as is illustrated in the following Examples, the piezoelectric ceramic composition according to the present invention comprising a predetermined amount of Al₂O₃ is effective for resonator miniaturization because unnecessary vibrations can be suppressed.

A preferred Al₂O₃ amount is 2 to 6% by weight, and a more preferred Al₂O₃ amount is 2 to 4% by weight. If the Al₂O₃ is in this range, the above-described heat resisting property |ΔF₀| can be 0.05% or less. Further, if the Al₂O₃ is in this range, the electromechanical coupling factor k₁₅ can fall within a preferable range for a resonator such that 38% or less, or 37% or less. In addition, if the Al₂O₃ amount is 6% by weight or less, the electrical property Qₘₐₓ can be 70 or higher, further 90 or higher, and if the Al₂O₃ amount is 4% by weight or less, the electrical property Qₘₐₓ can be 100 or higher.

### <Production Method>

Next, a preferred method for producing the piezoelectric ceramic composition according to the present invention will be described in order of its steps.

### (Raw Material Powders and Weighing Out)

Used as the raw materials for the main component are powders of oxides or of compounds which are converted to oxides when heated. More specifically, PbO powder, TiO₂ powder, ZrO₂ powder, MnCO₃ powder, Nb₂O₅ powder and the like can be used. The raw material powders are each weighed to form the composition represented by formula (2). Then, based on the total weight of the main component raw material powders which were weighed, 1 to 10% by weight of Al₂O₃ powder as an additive raw material powder is added. The mean particle size of the raw material powders may be appropriately selected in the range of 0.1 to 3.0 μm.

Moreover, without being limited to the above described raw material powders, a powder of a composite oxide containing two or more metals may also be used as a raw material powder.

### (Calcination)

The raw material powders are subjected to wet mixing, and the resultant mixture is then calcined while being maintained at a temperature in the range of 700 to 950° C. for a predetermined period of time. The atmosphere during calcination may be N₂ or air. The maintained time for the calcination may be appropriately selected in the range of 0.5 to 5 hours. The calcined body is milled after the calcination.

It was described above that the raw material powders of the main component are mixed together with the raw material powder of the additive and then the resultant mixture is subjected to calcination. However, the timing for adding the raw material powder of the additive is not limited to the above-described timing. For example, first, the powders of the main component may be weighed out, mixed, calcined and milled, and then, to the main component powder obtained by milling, the raw material powder of the additive may be added in a predetermined amount and mixed therein.

### (Granulation and Compacting)

The milled powder is formed into granules for the purpose of smoothly carrying out the subsequent compacting step. At this time, a small amount of an appropriate binder, for example, polyvinyl alcohol (PVA) is added to the milled powder, and the resultant mixture is thoroughly mixed. Then, a granulated powder is obtained by passing the mixture through a mesh, for example, to size the granules. The resultant granulated powder is then subjected to pressure-compacting at a pressure of 200 to 300 MPa to obtain a compacted body having a desired shape.

### (Sintering)

After the binder added during compacting has been removed, the compacted body is heated and maintained at a temperature in the range of 1,170 to 1,250° C. for a predetermined period of time to obtain a sintered body. The atmosphere during sintering may be N₂ or air. The maintained heating time may be appropriately set in the range of 0.5 to 4 hours.

### (Polarization)

After the electrodes used for polarization have been formed on the sintered body, polarization is carried out. The polarization is conducted at a temperature of 50 to 300° C. by applying an electric field of 1.0 to 2.0 Ec (Ec being the coercive field) to the sintered body for 0.5 to 30 minutes.

The polarization is conducted in a bath of an insulating oil such as silicon oil heated to the above-described temperature. It is preferable to carry out heat aging in a temperature range of 150 to 250° C. immediately after polarization.

The sintered body (piezoelectric ceramic) is lapped to a desired thickness, and thereafter vibrating electrodes are formed. Then, after cutting into a desired shape with a dicing saw or the like, the piezoelectric ceramic can function as a piezoelectric element. The piezoelectric ceramic composition according to the present invention can be suitably used especially for a resonator.

### <Properties of the Piezoelectric Ceramic Composition>

### (Heat Resisting Property)

The piezoelectric ceramic composition according to the present invention has excellent heat resisting property. In the present invention, heat resisting property |ΔF₀| relating to the oscillation frequency F₀ was evaluated. |ΔF₀| is, as described above, given by formula (1). The piezoelectric ceramic composition according to the present invention may have heat resisting property |ΔF₀| relating to the oscillation frequency F₀ of 0.05% or less. Here, if an equivalent circuit constant is used, the oscillation frequency F₀ has the relationship defined in the following formulae (3) to (6). In formulae (3) to (6), F₀ represents the oscillation frequency, Fr represents the resonant frequency, Fa represents the anti-resonant frequency, C₁ represents the motional capacitance, C₀ represents the shunt capacitance, C_{L} is defined in formula (6), Cd represents a free capacitance, and C_{L1} and C_{L2} each represent a load capacitance. As shown in formula (3), four parameters, resonant frequency Fr, motional capacitance C₁, shunt capacitance C₀ and C_{L} affect the value of the oscillation frequency F₀. Further, as shown in formulae (4) to (6), motional capacitance C₁, shunt capacitance C₀ and C_{L} are each associated with plural parameters.

$$\begin{matrix}{F}_{0} = Fr \sqrt{1 + \frac{{C}_{1}}{{C}_{0} + {C}_{L}}} & formula ( 3 ) \\ {C}_{1} = \frac{{Fa}^{2} - {Fr}^{2}}{{Fa}^{2}} Cd & formula ( 4 ) \\ {C}_{0} = Cd - {C}_{1} & formula ( 5 ) \\ \begin{matrix}{C}_{L} = \frac{{C}_{L 1} \cdot {C}_{L 2}}{{C}_{L 1} + {C}_{L 2}} \\ ⇒ \frac{{C}_{L 1}}{2} ( {C}_{L 1} = {C}_{L 2} )\end{matrix} & formula ( 6 )\end{matrix}$$

### Example 1

As the raw materials, prepared were lead oxide (PbO) powder, titanium oxide (TiO₂) powder, zirconium oxide (ZrO₂) powder, manganese carbonate (MnCO₃) powder, niobium oxide (Nb₂O₅) powder and aluminum oxide (Al₂O₃) powder. These raw material powders were weighed out so as to form the compositions shown in Tables 1 to 3, and the resultant mixtures were wet-mixed in pure water for 0.5 hours by a ball mill (using Zr balls).

The obtained slurry was thoroughly dried, press-compacted and then calcined in air at 800 to 950° C. Then the calcined body was finely milled by a ball mill to have a mean particle size of 0.7 μm, and the finely milled powder was then dried. The dried, finely milled powder was added with an appropriate amount of PVA (polyvinyl alcohol) as a binder, and the resultant mixture was granulated.

About 3 g of the granulated powder was charged into a die cavity having a 20 mm length and a 20 mm width, and then compacted under a pressure of 245 MPa using a uniaxial press machine. The obtained compacted body was subjected to a treatment for removing the binder, and was then sintered at 1,170 to 1,250° C. for 2 hours in air to obtain a sintered body.

Both surfaces of the sintered body were flattened by a lapping machine to a thickness of 0.350 mm. The sintered body was then cut to a size of 15 mm in length and 15 mm in width using a dicing saw, and temporary electrodes (14 mm in length×14 mm in width) for polarization were formed on both the upper and lower surfaces. Then, the sintered body was polarized to have a thickness-shear vibration mode by applying an electric field of 3 kV/mm for 15 minutes while in a silicon oil bath at 150° C. The temporary electrodes were then removed, and the sample was subjected to heat aging in a temperature range of 150 to 250° C. in order to stabilize its properties. Here, the size of the sample after removing the temporary electrodes was 15 mm in length×15 mm in width×0.35 mm in thickness. The sample was lapped again by a lapping machine to a thickness of about 0.320 mm, and then cut using a dicing saw to have a length of 3.20 mm and a width of 0.60 mm.

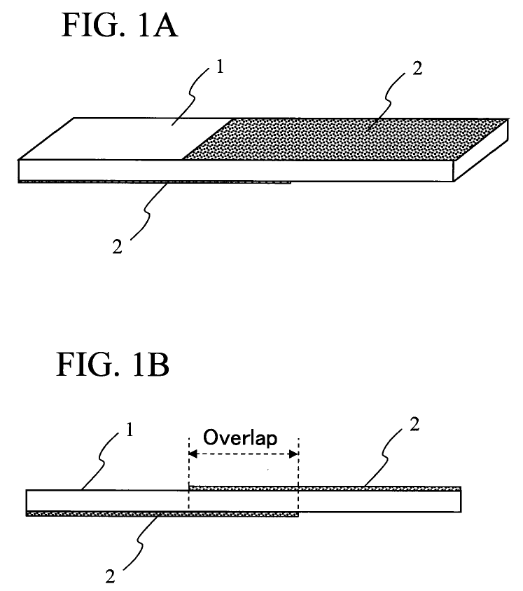

Then, as illustrated in FIG. 1A, a sample for measuring was produced by forming vibrating electrodes 2 on both surfaces (both lapped surfaces) of the specimen 1 using a vacuum evaporation apparatus. FIG. 1B illustrates the cross-section of the specimen 1. The overlap of the vibrating electrodes 2 was made to be 1.5 mm. The vibrating electrodes 2 were formed of a 0.01 μm-thick Cr sublayer and a 2 μm-thick Ag layer.

The |ΔF₀| for the above specimen 1 was determined. The results are shown in Tables 1 to 3. |ΔF₀| was determined by measuring the oscillation frequency F₀ with a frequency counter (53181A manufactured by Agilent Technologies) and calculating according to the above-described formula (1).

The electromechanical coupling factor k₁₅ for the above specimen 1 was determined. The electromechanical coupling factor k₁₅ was determined by measuring the resonant frequency Fr and anti-resonant frequency Fa in the vicinity of about 4 MHz using an impedance analyzer (4294A manufactured by Agilent Technologies), and calculating according to the following formula (7). The results are shown in Table 1.

$${k}_{15} = \sqrt{\frac{π}{2} \cdot \frac{Fr}{Fa} cot ( \frac{π}{2} \cdot \frac{Fr}{Fa} )} \qquad formula ( 7 )$$

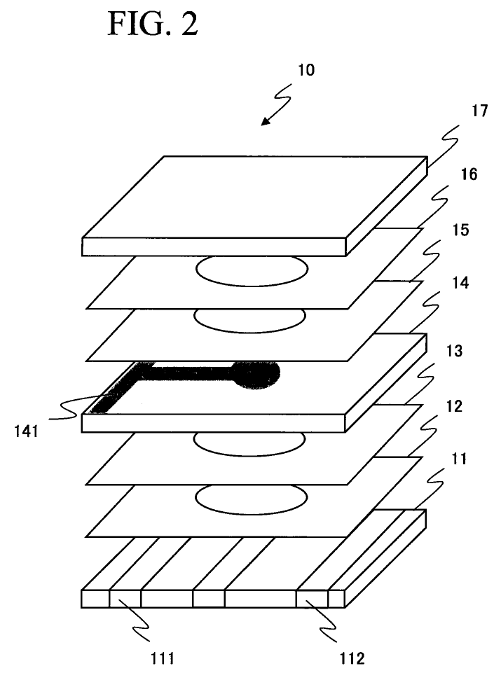

Using the above-obtained samples, the resonator illustrated in FIG. 2 was actually prepared. The impedance and phase curve were measured using the above-described impedance analyzer to determine whether any unnecessary vibrations (spurious vibrations) were present. The resonator 10 illustrated in FIG. 2 has a structure in which, on a substrate 11 provided with terminal electrodes 111 and 112, are successively layered an adhesive resin layer 12, a cavity resin layer 13, a piezoelectric resonator 14 provided with a vibrating electrode 141, a cavity resin layer 15, an adhesive resin layer 16 and a cover 17. The piezoelectric resonator 14 is constituted by the above-described sample. This piezoelectric resonator 14 is supported on the substrate 11 via the adhesive resin layer 12 and the cavity resin layer 13. The cavity resin layers 13 and 15 are disposed to provide a vibration space so that the vibrations confined in the vicinity of the vibrating electrode 141 are not suppressed. To ensure that this space is maintained and ensure its air tightness, the cavity resin layers are adhered to the cover 17 by the adhesive resin layer 16.

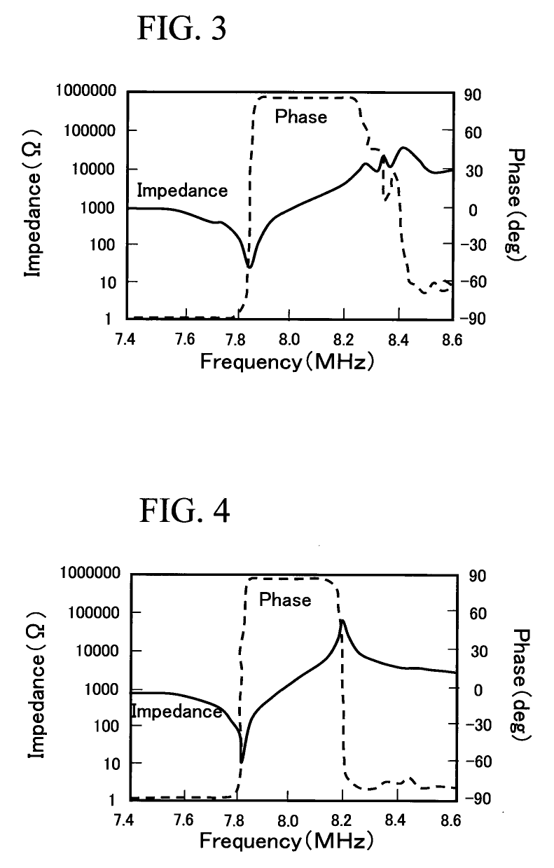

FIG. 3 illustrates the wave form of the impedance and phase curve when spurious vibrations were generated. FIG. 4 illustrates the wave form of the impedance and phase curve when spurious vibrations were not generated.

Further, the electrical property Qₘₐₓ for the above-described piezoelectric element was measured. Qₘₐₓ represents the maximum value of Q (=tan θ; θ being the phase angle (deg)) between the resonant frequency Fr and anti-resonant frequency Fa, which is an important property for resonators that serves as an index of low voltage drive. The results are shown in Tables 1 to 3.

TABLE 1

| | | | | | | | | Heat | | Spurious | | | |
|---|---|---|---|---|---|---|---|---|---|---|---|---|---|
| | Main Component (molar ratio) | | | | | | | resisting | Electromechanical | Vibrations | | Electrical | |
| Sample | a | b | c | | e | f | Additive | property | Coupling Factor | | Not | Property | |
| No. | (Pb) | (Mn) | (Nb) | d | (Ti) | (Zr) | Al₂O₃ (wt %) | \|Δ F₀\| (%) | k₁₅ (%) | Present | Present | Qmax | Remarks |
| *1 | 0.995 | 0.300 | 0.700 | 0.100 | 0.520 | 0.380 | 3 | 0.16 | 38.0 | | ∘ | 119 | |
| *2 | 0.995 | 0.317 | 0.683 | 0.100 | 0.520 | 0.380 | 3 | 0.12 | 37.9 | | ∘ | 109 | |
| *3 | 0.995 | 0.333 | 0.667 | 0.100 | 0.520 | 0.380 | 3 | 0.10 | 37.6 | | ∘ | 115 | |
| 4 | 0.995 | 0.340 | 0.660 | 0.100 | 0.520 | 0.380 | 3 | 0.03 | 37.0 | | ∘ | 120 | |
| 5 | 0.995 | 0.350 | 0.650 | 0.100 | 0.520 | 0.380 | 3 | 0.03 | 36.8 | | ∘ | 119 | |
| 6 | 0.995 | 0.384 | 0.616 | 0.100 | 0.520 | 0.380 | 3 | 0.03 | 36.6 | | ∘ | 113 | |
| *7 | 0.995 | 0.400 | 0.600 | 0.100 | 0.520 | 0.380 | 3 | — | — | — | — | — | Polarization |
| | | | | | | | | | | | | | Impossible |
| *8 | 0.995 | 0.300 | 0.700 | 0.100 | 0.520 | 0.380 | 5 | 0.17 | 37.9 | | ∘ | 103 | |
| *9 | 0.995 | 0.317 | 0.683 | 0.100 | 0.520 | 0.380 | 5 | 0.11 | 37.4 | | ∘ | 95 | |
| *10 | 0.995 | 0.333 | 0.667 | 0.100 | 0.520 | 0.380 | 5 | 0.10 | 37.0 | | ∘ | 102 | |
| 11 | 0.995 | 0.340 | 0.660 | 0.100 | 0.520 | 0.380 | 5 | 0.05 | 36.9 | | ∘ | 111 | |
| 12 | 0.995 | 0.350 | 0.650 | 0.100 | 0.520 | 0.380 | 5 | 0.03 | 36.5 | | ∘ | 102 | |
| 13 | 0.995 | 0.384 | 0.616 | 0.100 | 0.520 | 0.380 | 5 | 0.03 | 36.4 | | ∘ | 113 | |
| *14 | 0.995 | 0.400 | 0.600 | 0.100 | 0.520 | 0.380 | 5 | — | — | — | — | — | Polarization |
| | | | | | | | | | | | | | Impossible |

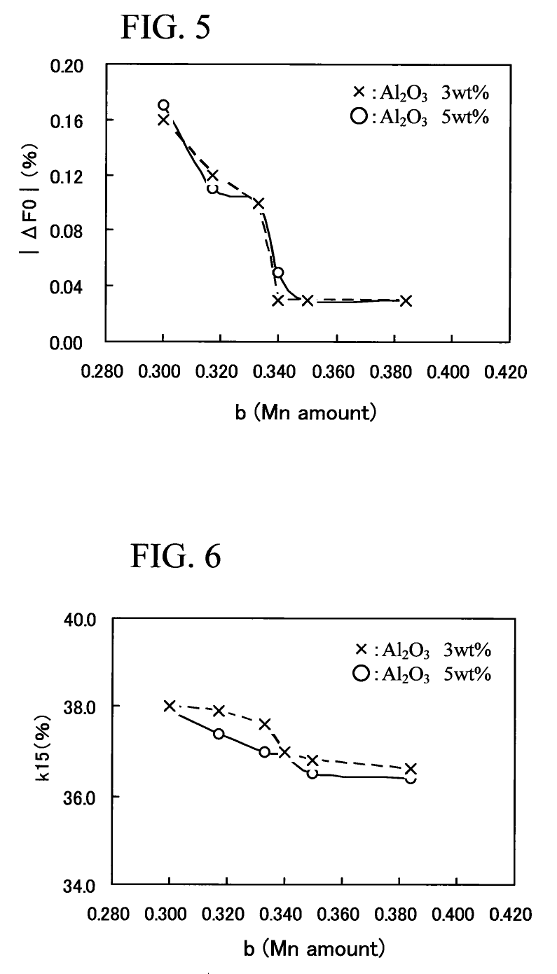

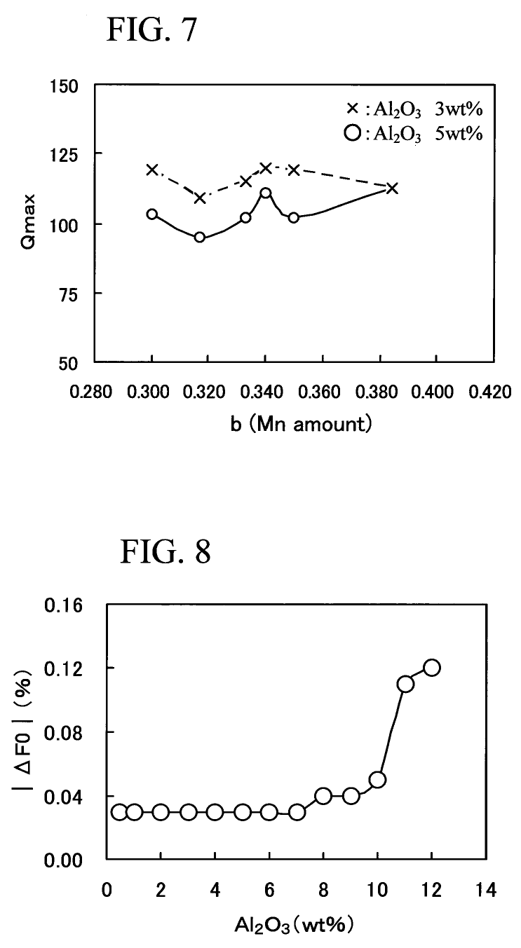

The relationship between b (Mn amount) in formula (2) and heat resisting property |ΔF₀| is illustrated in FIG. 5. The relationship between b in formula (2) and electromechanical coupling factor k₁₅ is illustrated in FIG. 6. The relationship between b in formula (2) and the electrical property Qₘₐₓ is illustrated in FIG. 7.

As illustrated in FIG. 5, it can be seen that heat resisting property |ΔF₀| improves as b increases. In particular, it can be seen that extremely excellent heat resisting property of |ΔF₀| of 0.05% or less is exhibited if the Mn is in the range defined by the present invention of 0.340≦b≦0.384, whereas |ΔF₀| is 0.10% if b is 0.333 (c is 0.667) wherein Mn is a stoichiometric composition. However, if b is further increased, polarization becomes impossible. In the present invention, therefore, b is defined as 0.340≦b≦0.384.

As illustrated in FIG. 6, it can be seen that the electromechanical coupling factor k₁₅ decreases as b decreases. For a resonator, a small electromechanical coupling factor k₁₅ is preferred. If b is in the range according to the present invention, the electromechanical coupling factor k₁₅ can be 37.0% or less.

In FIG. 7, there is a peak in electrical property Qₘₐₓ near the lower limit of b according to the present invention. However, as long as b is in the range according to the present invention, a high electrical property Qₘₐₓ of 100 or more can be obtained.

TABLE 2

| | | | | | | | | Heat | | Spurious | | |
|---|---|---|---|---|---|---|---|---|---|---|---|---|
| | Main Component (molar ratio) | | | | | | | resisting | Electromechanical | Vibrations | | Electrical |
| Sample | a | b | c | | e | f | Additive | property | Coupling Factor | | Not | Property |
| No. | (Pb) | (Mn) | (Nb) | d | (Ti) | (Zr) | Al₂O₃ (wt %) | \|Δ F₀\| (%) | k₁₅ (%) | Present | Present | Qmax |
| *15 | 0.990 | 0.350 | 0.650 | 0.100 | 0.520 | 0.380 | 0.5 | 0.03 | 39.0 | ∘ | | 136 |
| 16 | 0.990 | 0.350 | 0.650 | 0.100 | 0.520 | 0.380 | 1 | 0.03 | 37.8 | | ∘ | 133 |
| 17 | 0.990 | 0.350 | 0.650 | 0.100 | 0.520 | 0.380 | 2 | 0.03 | 37.0 | | ∘ | 121 |
| 18 | 0.990 | 0.350 | 0.650 | 0.100 | 0.520 | 0.380 | 3 | 0.03 | 36.9 | | ∘ | 104 |
| 19 | 0.990 | 0.350 | 0.650 | 0.100 | 0.520 | 0.380 | 4 | 0.03 | 36.5 | | ∘ | 107 |
| 20 | 0.990 | 0.350 | 0.650 | 0.100 | 0.520 | 0.380 | 5 | 0.03 | 36.1 | | ∘ | 98 |
| 21 | 0.990 | 0.350 | 0.650 | 0.100 | 0.520 | 0.380 | 6 | 0.03 | 35.5 | | ∘ | 94 |
| 22 | 0.990 | 0.350 | 0.650 | 0.100 | 0.520 | 0.380 | 7 | 0.03 | 35.0 | | ∘ | 86 |
| 23 | 0.990 | 0.350 | 0.650 | 0.100 | 0.520 | 0.380 | 8 | 0.04 | 33.9 | | ∘ | 82 |
| 24 | 0.990 | 0.350 | 0.650 | 0.100 | 0.520 | 0.380 | 9 | 0.04 | 31.9 | | ∘ | 74 |
| 25 | 0.990 | 0.350 | 0.650 | 0.100 | 0.520 | 0.380 | 10 | 0.05 | 29.1 | | ∘ | 73 |
| 26 | 0.990 | 0.350 | 0.650 | 0.100 | 0.520 | 0.380 | 11 | 0.11 | 29.0 | | ∘ | 60 |
| *27 | 0.990 | 0.350 | 0.650 | 0.100 | 0.520 | 0.380 | 12 | 0.12 | 29.1 | | ∘ | 51 |

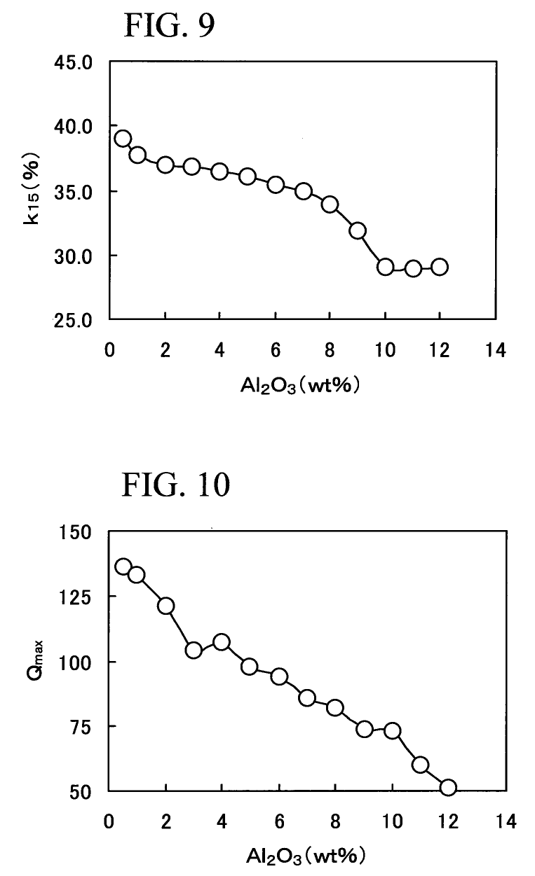

The relationship between the Al₂O₃ amount and heat resisting property |ΔF₀| is illustrated in FIG. 8. The relationship between Al₂O₃ amount and electromechanical coupling factor k₁₅ is illustrated in FIG. 9. The relationship between Al₂O₃ amount and the electrical property Qₘₐₓ is illustrated in FIG. 10.

If the Al₂O₃ amount is 0.5% by weight, spurious vibrations are generated and the electromechanical coupling factor k₁₅ exhibits a comparatively large value of 39.0%. In contrast, if the Al₂O₃ amount is 1.0% by weight or more, spurious vibrations are not generated and the electromechanical coupling factor k₁₅ exhibits a value of 38.0% or less. However, if the Al₂O₃ amount exceeds 10% by weight, the heat resisting property |ΔF₀| dramatically deteriorates. Therefore, the present invention sets the Al₂O₃ amount at 1 to 10% by weight.

As described above, for a resonator, the electromechanical coupling factor k₁₅ is preferably low. To obtain an electromechanical coupling factor k₁₅ of 37.0% or less, the Al₂O₃ amount is preferably 2% by weight or more. On the other hand, the electrical property Qₘₐₓ, which preferably has a high value, has a value of 90 or more when the Al₂O₃ amount is in the range of 6% by weight or less, and a value of 100 or more when the Al₂O₃ amount is in the range of 4% by weight or less. Thus, in consideration of the three properties of heat resisting property |ΔF₀|, electromechanical coupling factor k₁₅ and electrical property Qₘₐₓ, a preferred range for the Al₂O₃ amount is 2 to 6% by weight, and a more preferred range is 2 to 4% by weight.

TABLE 3

| | | | | | | | | Heat | | Spurious | | |
|---|---|---|---|---|---|---|---|---|---|---|---|---|
| | Main Component (molar ratio) | | | | | | | resisting | Electromechanical | Vibrations | | Electrical |
| Sample | a | b | c | | e | f | Additive | property | Coupling Factor | | Not | Property |
| No. | (Pb) | (Mn) | (Nb) | d | (Ti) | (Zr) | Al₂O₃ (wt %) | \|Δ F₀\| (%) | k₁₅ (%) | Present | Present | Qmax |
| 28 | 0.980 | 0.350 | 0.650 | 0.100 | 0.520 | 0.380 | 3 | 0.03 | 35.1 | | ∘ | 135 |
| 18 | 0.990 | 0.350 | 0.650 | 0.100 | 0.520 | 0.380 | 3 | 0.03 | 36.9 | | ∘ | 104 |
| 5 | 0.995 | 0.350 | 0.650 | 0.100 | 0.520 | 0.380 | 3 | 0.03 | 36.8 | | ∘ | 119 |
| 29 | 1.010 | 0.350 | 0.650 | 0.100 | 0.520 | 0.380 | 3 | 0.03 | 37.8 | | ∘ | 149 |
| 30 | 0.990 | 0.350 | 0.650 | 0.080 | 0.540 | 0.380 | 3 | 0.03 | 36.0 | | ∘ | 102 |
| 31 | 0.990 | 0.350 | 0.650 | 0.120 | 0.500 | 0.380 | 3 | 0.03 | 38.0 | | ∘ | 139 |
| 32 | 0.990 | 0.350 | 0.650 | 0.100 | 0.510 | 0.390 | 3 | 0.03 | 37.3 | | ∘ | 133 |
| 33 | 0.990 | 0.350 | 0.650 | 0.100 | 0.530 | 0.370 | 3 | 0.03 | 36.8 | | ∘ | 127 |
| 34 | 0.990 | 0.350 | 0.650 | 0.080 | 0.530 | 0.390 | 3 | 0.03 | 35.6 | | ∘ | 101 |
| 35 | 0.990 | 0.350 | 0.650 | 0.080 | 0.510 | 0.410 | 3 | 0.03 | 37.4 | | ∘ | 111 |
| 36 | 0.980 | 0.350 | 0.650 | 0.100 | 0.520 | 0.380 | 5 | 0.03 | 34.8 | | ∘ | 105 |
| 20 | 0.990 | 0.350 | 0.650 | 0.100 | 0.520 | 0.380 | 5 | 0.03 | 36.1 | | ∘ | 98 |
| 12 | 0.995 | 0.350 | 0.650 | 0.100 | 0.520 | 0.380 | 5 | 0.03 | 36.5 | | ∘ | 102 |
| 37 | 1.010 | 0.350 | 0.650 | 0.100 | 0.520 | 0.380 | 5 | 0.05 | 37.3 | | ∘ | 120 |
| 38 | 0.990 | 0.350 | 0.650 | 0.080 | 0.540 | 0.380 | 5 | 0.03 | 35.6 | | ∘ | 72 |
| 39 | 0.990 | 0.350 | 0.650 | 0.120 | 0.500 | 0.380 | 5 | 0.05 | 37.9 | | ∘ | 128 |
| 40 | 0.990 | 0.350 | 0.650 | 0.100 | 0.510 | 0.390 | 5 | 0.04 | 37.2 | | ∘ | 119 |
| 41 | 0.990 | 0.350 | 0.650 | 0.100 | 0.530 | 0.370 | 5 | 0.03 | 36.7 | | ∘ | 110 |
| 42 | 0.990 | 0.350 | 0.650 | 0.080 | 0.530 | 0.390 | 5 | 0.03 | 35.4 | | ∘ | 81 |
| 43 | 0.990 | 0.350 | 0.650 | 0.080 | 0.510 | 0.410 | 5 | 0.05 | 37.1 | | ∘ | 88 |

Looking at “a” (Pb amount) in formula (2), although the electromechanical coupling factor k₁₅ tends to increase as “a” increases, k₁₅ can be 38.0% or less in the range (0.98≦a≦1.01) according to the present invention. Further, in this range, an electrical property Qₘₐₓ of 100 or more can be obtained.

Further, similarly for d, e (Ti amount) and f (Zr amount) in formula (2), in the ranges (0.08≦d≦0.12, 0.500≦e≦0.540, 0.37≦f≦0.41) according to the present invention, an electromechanical coupling factor k₁₅ of 38.0% or less and an electrical property Qₘₐₓ of 70 or more were confirmed, thus exhibiting values which would have no problems in practical use as a resonator or other such applications.

What is claimed is:

1. A piezoelectric ceramic composition comprising:
a main component represented by a composition formula: Pbₐ[(Mn_{b}Nb_{c})_{d}TiₑZr_{f}]O₃, wherein in the composition formula a to f satisfy:
0.98≦a≦1.01,
0.340≦b≦0.384,
0.616≦c≦0.660,
0.08≦d≦0.12,
0.500≦e≦0.540,
0.37≦f≦0.41, and
bd+cd+e+f=1, and
1 to 10% by weight of Al in terms of Al₂O₃ as an additive.

2. The piezoelectric ceramic composition according to claim 1, comprising 2 to 6% by weight of Al as the additive in terms of Al₂O₃.

3. The piezoelectric ceramic composition according to claim 1, comprising 2 to 4% by weight of Al as the additive in terms of Al₂O₃.

4. A resonator comprising:
a piezoelectric resonator provided with a vibrating electrode formed thereon; and
a substrate for supporting the piezoelectric resonator, wherein
the piezoelectric resonator is constituted from a piezoelectric ceramic comprising:
a main component represented by a composition formula: Pbₐ[(Mn_{b}Nb_{c})_{d}TiₑZr_{f}]O₃, wherein in the composition formula a to f satisfy:
0.98≦a≦1.01,
0.340≦b≦0.384,
0.616≦c≦0.660,
0.08≦d≦0.12,
0.500≦e≦0.540,
0.37≦f≦0.41, and
bd+cd+e+f=1, and
1 to 10% by weight of Al in terms of Al₂O₃ as an additive.
